(19) United States
(12) Patent Application Publication
(10) Pub. No.: US 2025/0132377 A1
(43) Pub. Date: Apr. 24, 2025

(54) LITHIUM SULFUR BATTERY AND METHOD FOR MANUFACTURING LITHIUM SULFUR BATTERY

(71) Applicant: TOYOTA JIDOSHA KABUSHIKI KAISHA, Toyota-shi (JP)

(72) Inventor: Shinya Shiotani, Nagoya-shi (JP)

(73) Assignee: TOYOTA JIDOSHA KABUSHIKI KAISHA, Toyota-shi (JP)

(21) Appl. No.: 18/663,478

(22) Filed: May 14, 2024

(30) Foreign Application Priority Data
Oct. 19, 2023 (JP) 2023-180477

(51) Int. Cl. H01M 10/056; H01M 10/052

(52) U.S. Cl. CPC H01M 10/056; H01M 10/052; H01M 2300/008; H01M 2300/0085; H01M 2300/0094

(57) ABSTRACT

A lithium sulfur battery, wherein the lithium sulfur battery comprises a cathode layer, a first solid electrolyte layer, a second solid electrolyte layer, and an anode layer in this order, wherein the first solid electrolyte layer comprises a sulfide solid electrolyte, and the second solid electrolyte layer comprises a polymer electrolyte and/or a gel electrolyte.

### CROSS-REFERENCE TO RELATED APPLICATION

This application claims priority to Japanese Patent Application No. 2023-180477 filed on Oct. 19, 2023, incorporated herein by reference in its entirety.

### BACKGROUND

### 1. Technical Field

The present disclosure relates to a lithium sulfur battery and a method for manufacturing the lithium sulfur battery.

### 2. Description of Related Art

A lithium sulfur battery is a battery using sulfur as a cathode active material, and sulfur has a high theoretical capacity. Therefore, the lithium sulfur battery attracts attention as a next-generation battery. In a liquid type lithium sulfur battery, capacity degradation occurs due to elution of lithium polysulfide into an electrolyte solution. Therefore, a solid type lithium sulfur battery including a solid electrolyte layer has been developed. The following solid type lithium sulfur battery is known.

For example, Japanese Unexamined Patent Application Publication No. 2023-009988 (JP 2023-009988 A) discloses the following all-solid-state battery. The all-solid-state battery includes a first electrode layer, a first solid electrolyte layer, a second solid electrolyte layer, and a second electrode layer in this order. The first solid electrolyte layer has a first surface. The second solid electrolyte layer has a second surface in contact with the first surface. A maximum height Rz₁ of the first surface and a maximum height Rz₂ of the second surface satisfy the following predetermined relationship. With the all-solid-state battery of JP 2023-009988 A, even when a crack occurs in one of the first solid electrolyte layer and the second solid electrolyte layer, propagation of the crack to other layers is easily suppressed, and excellent short-circuit resistance is easily secured.

### SUMMARY

The solid electrolyte layer containing a sulfide solid electrolyte has excellent characteristics as the solid electrolyte layer, but cannot follow expansion and contraction caused along with charging and discharging of a cathode layer containing sulfur, and a crack may occur in the solid electrolyte layer to cause a short circuit. When a solid electrolyte layer that follows expansion and contraction is used to prevent the short circuit, the capacity may remarkably decrease. Therefore, further improvement is demanded in the solid electrolyte layer of the lithium sulfur battery.

In view of the above, an object of the present disclosure is to provide a lithium sulfur battery in which a short circuit caused along with charging and discharging can be suppressed and a high battery capacity can be obtained.

The present disclosure achieves the above object by the following means.

### First Aspect

A lithium sulfur battery including
a cathode layer, a first solid electrolyte layer, a second solid electrolyte layer, and an anode layer in the stated order, in which
the first solid electrolyte layer includes a sulfide solid electrolyte, and
the second solid electrolyte layer includes a polymer electrolyte and/or a gel electrolyte.

### Second Aspect

The lithium sulfur battery according to the first aspect, in which:
the anode layer includes an anode current collector layer; and
lithium ions that have migrated from the cathode layer during charging are deposited as metallic lithium between the second solid electrolyte layer and the anode current collector layer.

### Third Aspect

The lithium sulfur battery according to the first or second aspect, in which
the second solid electrolyte layer includes the polymer electrolyte.

### Fourth Aspect

The lithium sulfur battery according to any one of the first to third aspects, in which the polymer electrolyte includes polyethylene oxide.

### Fifth Aspect

A method for manufacturing the lithium sulfur battery according to any one of the first to fourth aspects, the method including the steps of:
forming a preliminary laminate by laminating a preliminary cathode layer containing sulfur and a sulfide containing a phosphorus element and a sulfur element, the first solid electrolyte layer, the second solid electrolyte layer, and the anode layer in the stated order; and
forming the cathode layer by generating a sulfide solid electrolyte by causing part of the sulfur and the sulfide containing the phosphorus element and the sulfur element in the preliminary cathode layer to react with lithium through a discharge operation on the preliminary laminate.

With the lithium sulfur battery of the present disclosure, the short circuit caused along with charging and discharging can be suppressed and a high battery capacity can be obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram for explaining a lithium sulfur battery of the present disclosure.

### DETAILED DESCRIPTION OF EMBODIMENTS

Hereinafter, embodiments of the present disclosure will be described in detail. Note that the present disclosure is not limited to the following embodiments, and various modifications can be made within the scope of the gist of the present disclosure. In the description of the drawings, the same elements are denoted by the same reference numerals, and redundant description will be omitted.

The lithium sulfur battery of the present disclosure is a solid battery having a solid electrolyte layer as an electrolyte layer. In the context of the present disclosure, a “solid battery” means a battery using at least a solid electrolyte as an electrolyte, and therefore a solid battery may use a combination of a solid electrolyte and a liquid electrolyte as an electrolyte.

In the context of the present disclosure, “mixture” means a composition that can constitute a positive electrode (negative electrode) layer or a solid electrolyte layer as it is or by further containing other components. In addition, in the context of the present disclosure, a “mixture slurry” means a slurry containing a dispersion medium in addition to a “mixture” and thus can be applied and dried to form a positive electrode (negative electrode) layer or a solid electrolyte layer.

### Lithium Sulfur Battery

The lithium sulfur battery of the present disclosure includes:
A cathode layer, a first solid electrolyte layer, a second solid electrolyte layer, and an anode layer in this order,
The first solid electrolyte layer includes a sulfide solid electrolyte, and
The second solid electrolyte layer comprises a polymer electrolyte and/or a gel electrolyte.

According to the lithium sulfur battery of the present disclosure, it is possible to suppress a short circuit caused by charging and discharging and to obtain a high battery capacity.

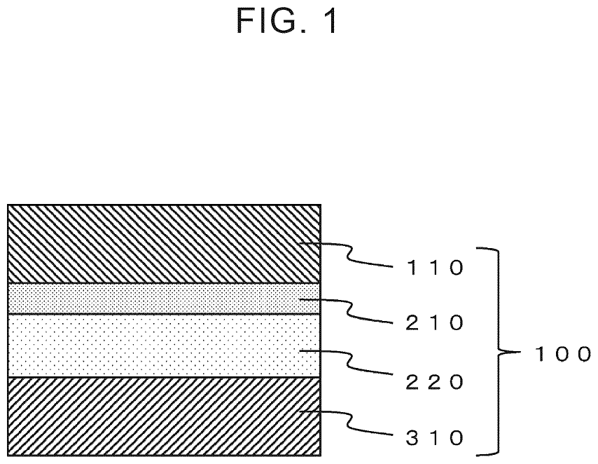

Specifically, the lithium sulfur battery of the present disclosure includes, for example, as shown in FIG. 1, a cathode layer 110, a first solid electrolyte layer 210 including a sulfide solid electrolyte, a second solid electrolyte layer 220 including a polymer electrolyte and/or a gel electrolyte, and an anode layer 310. When charging and discharging are performed, the cathode layer 110 containing sulfur as the positive electrode active material expands and contracts.

The lithium sulfur battery of the present disclosure has a second solid electrolyte layer comprising a polymer electrolyte and/or a gel electrolyte. Since the second solid electrolyte layer includes the polymer electrolyte layer and/or the gel electrolyte layer, it is presumed that the second solid electrolyte layer is relatively flexible and can follow the expansion and contraction associated with charging and discharging of the cathode layer containing sulfur, thereby suppressing a short circuit.

In addition, the lithium sulfur battery of the present disclosure has a first solid electrolyte layer including a sulfide solid electrolyte between a cathode layer and a second solid electrolyte layer including a polymer electrolyte and/or a gel electrolyte. Since the first solid electrolyte layer is a sulfide solid electrolyte, it is presumed that the barrier of lithium insertion into the cathode layer can be reduced, and thereby the lithium sulfur battery can obtain a high battery capacity.

### Configuration of Lithium Sulfur Battery

The lithium sulfur battery of the present disclosure includes a cathode layer, a first solid electrolyte layer, a second solid electrolyte layer, and an anode layer in this order.

### Cathode Layer

The cathode layer includes at least a positive electrode active material. When the battery is charged, lithium ions move from the positive electrode active material to the anode layer via the first solid electrolyte layer and the second solid electrolyte layer. When the battery is discharged, lithium in the anode layer is ionized and returned to the positive electrode active material. The cathode layer includes a positive electrode active material layer and an optional positive electrode current collector layer.

### Positive Electrode Current Collector Layer

A material used for the positive electrode current collector layer is not particularly limited, but a material generally used as a positive electrode current collector of a lithium sulfur battery can be appropriately adopted. Examples of materials used for the positive electrode current collector layers include, but are not limited to, Cu, Ni, Cr, Au, Pt, Ag, Al, Fe, Ti, Zn, Co, and stainless-steel. Further, the positive electrode current collector layer may have some coating layer on the surface thereof for the purpose of adjusting the resistance or the like. The positive electrode current collector layer may be formed by plating or depositing the metal on a metal foil or a base material.

The shape of the positive electrode current collector layer is not particularly limited, but may be, for example, a foil shape, a plate shape, or a mesh shape. Among the above, the foil shape is preferred.

The thickness of the positive electrode current collector layers is not particularly limited, but may be 0.1 μm or more, or 1 μm or more, and may be 1 mm or less, or 100 μm or less.

### Positive Electrode Active Material Layer

The positive electrode active material layer contains at least sulfur as a positive electrode active material, and may optionally contain a conductive auxiliary agent, a binder, a solid electrolyte, and the like. The positive electrode active material layer may further contain various additives. The content of each of the positive electrode active material, the conductive auxiliary agent, the binder, the solid electrolyte, and the like in the positive electrode active material layer may be appropriately determined in accordance with the desired battery performance. For example, the content of the positive electrode active material may be 40% by mass or more, 50% by mass or more, or 60% by mass or more, or 100% by mass or less, or 90% by mass or less, based on 100% by mass of the entire positive electrode active material layer (the entire solid content).

### Positive Electrode Active Material

As described above, at least sulfur is used as the positive electrode active material. The sulfur may function as a positive electrode active material, may be elemental sulfur, or may be a sulfur compound.

The positive electrode active material layer may contain a positive electrode active material other than elemental sulfur or a sulfur compound. Examples of the positive electrode active material other than the elemental sulfur and the sulfur compound include various lithium-containing compounds. For example, lithium-containing compounds may include lithium cobaltate (LiCoO₂), lithium nickel oxide (LiNiO₂), lithium manganate (LiMn₂O₄), nickel cobalt lithium manganate (NCM), LiCO_{1/3}Ni_{1/3}Mn_{1/3}O₂, nickel cobalt lithium aluminium (NCA; LiNiₓCo_{y}Al₂O₂). The lithium-containing compound may be a heterogeneous element-substituted Li—Mn spinel or the like having a composition represented by Li₁₊ₓMn_{2-x-y}M_{y}O₄ (M is one or more metallic elements selected from Al, Mg, Co, Fe, Ni, and Zn). However, the lithium-containing compound is not limited thereto.

The ratio of the single sulfur and sulfur compounds contained in the positive electrolyte active material layer may be, but not limited to, 50 mass % to 100 mass %, 60 mass % to 100 mass %, 70 mass % to 100 mass %, 80 mass % to 100 mass %, or 90 mass % to 100 mass %.

The shape of the positive electrode active material is not particularly limited as long as it is a general shape as a positive electrode active material of a lithium sulfur battery. The positive electrode active material may be in a particulate form, for example. The positive electrode active material may be a solid material, a hollow material, a void material, or a porous material. The positive electrode active material may be a primary particle or a secondary particle in which a plurality of primary particles is aggregated. The mean particle diameter D₅₀ of the positive electrode active material may be, for example, greater than or equal to 1 nm, greater than or equal to 5 nm, or greater than or equal to 10 nm, and may be less than or equal to 500 μm, less than or equal to 100 μm, less than or equal to 50 μm, or less than or equal to 30 μm. The mean particle diameter D₅₀ is the particle diameter (median diameter) at an integrated value of 50% in the volume-based particle size distribution determined by the laser diffraction/scattering method.

### Conductive Aid

The conductive aid is not particularly limited. The conductive aid may be, for example, but not limited to, vapor deposited carbon fiber (VGCF), acetylene black (AB), Ketjen black (KB), carbon nanotube (CNT), carbon nanofiber (CNF), and the like. The conductive auxiliary agent may be, for example, particulate or fibrous, and the size thereof is not particularly limited. The conductive auxiliary agent is not particularly limited, but only one kind may be used alone, or two or more kinds may be used in combination.

### Binder

The binder is not particularly limited. The binder may be a material such as, but not limited to, polyvinylidene fluoride (PVdF), butadiene rubber (BR), polytetrafluoroethylene (PTFE), styrene butadiene rubber (SBR), and the like. The binder is not particularly limited, but only one binder may be used alone, or two or more binders may be used in combination.

### Solid Electrolyte

The material of the solid electrolyte is not particularly limited, and may be a sulfide solid electrolyte, an oxide solid electrolyte, a polymer electrolyte, or the like.

For the sulfide solid electrolyte, the description of “first solid electrolyte layer” described later can be referred to. For the polymer electrolyte, reference can also be made to the description of “second solid electrolyte layer” described later.

Examples of an oxide solid-state electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x} TiO₃, Li₁₊ₓAlₓTi₂₋ₓ(PO₄)₃, Li₁₊ₓAlₓGe₂₋ₓ(PO₄)₃, Li₃PO₄, Li₃₊ₓPO₄₋ₓNₓ(LiPON), or the like. However, the oxide solid electrolyte is not limited thereto.

The oxide solid electrolyte may be glass or crystallized glass (glass ceramics).

The shape of the positive electrode active material layer is not particularly limited, but may be, for example, a sheet-like positive electrode active material layer having a substantially flat surface. The thickness of the positive electrode active material layer is not particularly limited, but is, for example, 0. The thickness may be 1 μm or more, 1 μm or more, or 10 μm or more, and may be 2 mm or less, 1 mm or less, or 500 μm or less.

The cathode layer can be produced by applying a known method. For example, the positive electrode active material layer can be easily formed by, for example, dry or wet molding of a positive electrode mixture containing the above-described various components. The positive electrode active material layer may be formed together with the positive electrode current collector layer, or may be formed separately from the positive electrode current collector layer.

### First Solid Electrolyte Layer

In the lithium sulfur battery of the present disclosure, the first solid electrolyte layer includes a sulfide solid electrolyte.

The first solid electrolyte layer includes a sulfide solid electrolyte, and may optionally include a binder or the like.

### Sulfide Solid Electrolyte

Examples of sulfide solid electrolyte include, but are not limited to, a sulfide-based amorphous solid electrolyte, a sulfide-based crystalline solid electrolyte, an aldirodite-type solid electrolyte, and the like. Examples of a specific sulfide solid electrolyte can include Li₂S—P₂S₅ system (Li₂P₃S₁₁, Li₃PS₄, Li₈P₂S₉, etc.), Li₂S—SiS₂, Lil-Li₂S—SiS₂, Lil-Li₂S—P₂P₅, Lil-LiBr—Li₂S—P₂S₅, Li₂S—P₂S₅—GeS₂ (Li₁₃GeP₃S₁₆, Li₁₀GeP₂S₁₂, etc.), Lil-Li₂S—P₂O₅, Lil-Li₃PO₄—P₂S₅, Li₇₋ₓPS₆₋ₓClₓ; or the like; or combinations thereof.

However, the sulfide solid electrolyte is not limited thereto.

The sulfide solid electrolyte may be glass or crystallized glass (glass ceramics).

For the binder, reference can be made to the description of “positive electrode active material layer” described above.

The thickness of the first solid electrolyte layer is not particularly limited, but may be, for example, 0.1 μm or more, 1 μm or more, or 10 μm or more, and may be 2 mm or less, 1 mm or less, or 500 μm or less.

The first solid electrolyte layer can be easily formed by, for example, dry or wet molding an electrolyte mixture containing the sulfide solid electrolyte and the binder described above.

### Second Solid Electrolyte Layer

In the lithium sulfur battery of the present disclosure, the second solid electrolyte layer includes a polymer electrolyte and/or a gel electrolyte. The second solid electrolyte layer is not particularly limited, but preferably includes a polymer electrolyte.

### Polymer Electrolyte

The polymer electrolyte refers to an electrolyte having a content of a solvent component of 5% by mass or less. The content of the solvent may be 3% by mass or less, or 1% by mass or less.

The polymer electrolyte comprises at least a polymer component. Polymer components include, but are not limited to, polyether-based polymers, polyester-based polymers, polyamine-based polymers, polysulfide-based polymers, and the like. From the viewpoint of mechanical properties such as ion conductivity and Young's modulus, polyether-based polymers are preferred.

The polyether-based polymer is not particularly limited, but is preferably polyethylene oxide. That is, the polymer electrolyte is not particularly limited, but preferably contains polyethylene oxide.

The polyether-based polymer is not particularly limited, but preferably has a polyether structure in the main chain of the repeating unit. Examples of the polyether structure include, but are not limited to, a polyethylene oxide (PEO) structure and a polypropylene oxide (PPO) structure.

The polyether-based polymer is not particularly limited, but preferably has a PEO configuration as the main repeating units. The percentage of PEO construction may be, for example, 50 to 100 mol %, 60 to 100 mol %, 70 to 100 mol %, 80 to 100 mol %, or 90 to 100 mol %. The polyether-based polymer may be, for example, a homopolymer or a copolymer of an epoxy compound (for example, ethylene oxide or propylene oxide).

The polymer component may include an ion conductive unit shown below. Examples of the ion conductive unit include polyethylene oxide, polypropylene oxide, polymethacrylic acid ester, polyacrylic acid ester, polydimethylsiloxane, polyacrylic acid, polymethacrylic acid, polyethylene vinyl acetate, polyimide, polyamine, polyamide, polyalkyl carbonate, polynitrile, polyphosphazene, polyolefin, and polydiene.

The weight-average molecular weight of the polymer component is not particularly limited, but is, for example, 1,000,000 to 10,000,000 or less. The weight-average molecular weight can be determined by gel permeation chromatography (GPC).

As the polymer electrolyte, only one type of polymer component may be used alone, or two or more types may be used in combination. The polymer electrolyte may be a crosslinked polymer electrolyte in which a polymer component is crosslinked, or an uncrosslinked polymer electrolyte in which a polymer component is not crosslinked.

The polymer electrolyte may contain a supporting salt (lithium salt). The support salt (lithium salt) is not particularly limited, and examples thereof include an inorganic lithium salt and an organic lithium salt. Examples of the inorganic lithium salt include, but are not limited to, LiPF₆, LiBF₄, LiClO₄, LiAsF₆. As the organic lithium salt, for example, LiCF₃SO₃, LiN(CF₃SO₂)₂, LiN(C₂F₅SO₂)₂, LiN(FSO₂)₂, LiC(CF₃SO₂)₃ and the like are not limited to this case. For example, when the polymer electrolyte has EO units (C₂H₅O units), EO units may be, but are not particularly limited to, 5 parts by mole or more, 10 parts by mole or more, or 15 parts by mole or more, and may be 40 parts by mole or less and 30 parts by mole or less, with respect to one support salt part by mole.

### Gel Electrolytes

The gel electrolyte contains an electrolyte solution in addition to the polymer electrolyte.

### Electrolytic Solution

The electrolyte solution is not particularly limited, but preferably contains a supporting salt and a solvent. For support salts, reference may be made to the description of “(polymer electrolyte)” above.

The solvent used in the electrolytic solution is not particularly limited, and examples thereof include cyclic carbonate and chain carbonate. Examples of the cyclic carbonate include, but are not limited to, ethylene carbonate (EC), propylene carbonate (PC), and butylene carbonate (BC). Examples of the linear carbonate include, but are not limited to, dimethyl carbonate (DMC), diethyl carbonate (DEC), ethyl methyl carbonate (EMC), and the like. Examples of the solvent include, but are not limited to, acetates such as methyl acetate and ethyl acetate, and ethers such as 2-methyltetrahydrofuran. Examples of the solvents include, but are not limited to, γ-butyl lactone, sulfolane, N-methyl pyrrolidone (NMP), 1,3-dimethyl-2-imidazolidinone (DMI), and the like. The solvent may also be water.

The thickness of the second solid electrolyte layer is not particularly limited, but may be, for example, 0.1 μm or more, 1 μm or more, or 10 μm or more, and may be 2 mm or less, 1 mm or less, or 500 μm or less.

The second solid electrolyte layer can be easily formed, for example, by dissolving the above-described polymer electrolyte and/or gel electrolyte, a supporting salt, and the like in a solvent and forming the same from a second solid electrolyte layer precursor solution containing the above-described various components.

### Anode Layer

The anode layer may include only the anode current collector layer or a negative electrode active material layer and an anode current collector layer. Lithium ions that have migrated from the positive electrode during charging of the battery may receive electrons and precipitate as metallic lithium between the second solid electrolyte layer and the anode current collector layer. In addition, lithium ions that have moved from the positive electrode during charging of the battery may receive electrons and be held in the negative electrode active material of the negative electrode active material layer. When the battery is discharged, lithium in the anode layer is ionized and returned to the cathode layer.

### Negative Electrode Active Material Layer

The negative electrode active material layer includes at least a negative electrode active material, and may further optionally include a conductive auxiliary agent, a binder, a solid electrolyte, and the like. The negative electrode active material layer may further contain various additives. The content of each of the negative electrode active material, the conductive auxiliary agent, the binder, the solid electrolyte, and the like in the negative electrode active material layer may be appropriately determined in accordance with the desired battery performance. For example, the content of the negative electrode active material may be 40% by mass or more, 50% by mass or more, or 60% by mass or more, and may be 100% by mass or less, or 90% by mass or less, with the total (total solid content) of the negative electrode active material layer being 100% by mass.

### Negative Active Material

As the negative electrode active material, various materials having a potential at which lithium ions are occluded and released (charge and discharge potential) which is a lower potential than that of the positive electrode active material of the present disclosure can be employed. The material of the negative electrode active material is not particularly limited, and may be metallic lithium or a material capable of occluding and releasing metallic ions such as lithium ions. Examples of materials capable of occluding and releasing metal ions such as lithium ions include alloy-based negative electrode active materials and carbon materials, but are not limited to these. Among them, the material of the negative electrode active material is not particularly limited, but metal lithium is preferable.

The alloy-based negative electrode active material is not particularly limited, and examples thereof include a Si alloy-based negative electrode active material, a Sn alloy-based negative electrode active material, and the like. The Si alloy-based negative electrode active materials include silicon, silicon oxides, silicon carbides, silicon nitrides, solid solutions thereof, and the like. Si alloy-based negative electrode active material may include a metallic element other than silicon, for example, Fe, Co, Sb, Bi, Pb, Ni, Cu, Zn, Ge, In, Sn, Ti or the like. The Sn alloy-based negative electrode active materials include tin, tin oxide, tin nitride, and solid solutions thereof. Sn alloy-based negative electrode active material may include a metallic element other than tin, for example, Fe, Co, Sb, Bi, Pb, Ni, Cu, Zn, Ge, In, Ti, Si or the like.

The carbon material is not particularly limited, and examples thereof include hard carbon, soft carbon, and graphite.

The shape of the negative electrode active material is not particularly limited, but may be any general shape as the negative electrode active material of the lithium sulfur battery. The negative electrode active material may be, for example, a sheet or a particle. The negative electrode active material may include lithium deposition during charging, or may include lithium dissolution during discharging. In this case, the negative electrode active material layer may be a layer made of metal lithium or a lithium alloy (for example, a metal lithium foil or a lithium alloy foil).

For the conductive auxiliary agent, the binder, and the solid electrolyte that can be included in the negative electrode active material layer, reference can be made to the above description of “positive electrode active material layer”.

The shape of the negative electrode active material layer is not particularly limited, but may be, for example, a sheet-like negative electrode active material layer having a substantially flat surface. The thickness of the negative electrode active material layer is not particularly limited, but the thickness may be, for example, 0.1 μm or more, 1 μm or more, or 10 μm or more, and may be 2 mm or less, 1 mm or less, or 500 μm or less.

### Anode Current Collector

A material used for the anode current collector layer is not particularly limited, but a material generally used as a negative electrode current collector of a lithium sulfur battery can be appropriately adopted. The anode current collector layer may be made of Cu, Ni, Cr, Au, Pt, Ag, Al, Fe, Ti, Zn, Co, stainless-steel, carbon sheet, or the like. In particular, from the viewpoint of ensuring reduction resistance and from the viewpoint of difficulty in alloying with lithium, the anode current collector layers may contain at least one metal selected from Cu, Ni, and stainless steel, or may be made of a carbon sheet. The anode current collector layer may have some coating layer on the surface thereof for the purpose of adjusting resistance or the like.

The shape of the anode current collector layer is not particularly limited, but may be, for example, a foil shape, a plate shape, or a mesh shape. Among them, a foil shape is preferable.

The thickness of the anode current collector layers is not particularly limited, but may be 0.1 μm or more, or 1 μm or more, and may be 1 mm or less, or 100 μm or less.

The anode layer can be produced by applying a known method. For example, the negative electrode active material layer can be easily formed by, for example, dry or wet molding of the negative electrode mixture containing the above various components. The negative electrode active material layer may be formed together with the anode current collector layer or may be formed separately from the anode current collector layer.

FIG. 1 is a schematic diagram illustrating one embodiment of a lithium sulfur battery of the present disclosure, but is not limited thereto.

The lithium sulfur battery 100 of FIG. 1 has a structure in which a cathode layer 110, a first solid electrolyte layer 210, a second solid electrolyte layer 220, and an anode layer 310 are stacked. The cathode layer 110 includes sulfur, and the first solid electrolyte layer 210 includes a sulfide solid electrolyte. The second solid electrolyte layer 220 includes a polymer electrolyte and/or a gel electrolyte. Since the second solid electrolyte layer includes a polymer electrolyte and/or a gel electrolyte, the second solid electrolyte layer is relatively flexible and can follow expansion and contraction associated with charging and discharging of the cathode layer containing sulfur, thereby suppressing a short circuit. In addition, since the first solid electrolyte includes a sulfide solid electrolyte, a barrier for lithium insertion into the cathode layer can be reduced, whereby a lithium sulfur battery can have a high battery capacity.

### Method for Producing Lithium Sulfur Battery

The lithium sulfur battery of the present disclosure can be manufactured by a manufacturing method including the following steps.

A preliminary laminate is formed by laminating a preliminary cathode layer containing sulfur and a sulfide containing a phosphorus element and a sulfur element, the first solid electrolyte layer, the second solid electrolyte layer, and the anode layer in this order.

By performing a discharge operation on the preliminary laminate, sulfur of a part of the preliminary cathode layer and a sulfide containing a phosphorus element and a sulfur element are reacted with lithium to form a sulfide solid electrolyte, thereby forming the cathode layer.

### Pre-Laminate Formation

The method may include laminating a preliminary cathode layer containing sulfur and a sulfide containing a phosphorus element and a sulfur element, the first solid electrolyte layer, the second solid electrolyte layer, and the anode layer in this order to form a preliminary laminate.

### Preliminary Cathode Layer

The preliminary cathode layer includes sulfur and a sulfide containing elemental phosphorus and elemental sulfur.

### Sulfides Containing Elemental Phosphorus and Elemental Sulfur

The sulfide includes at least elemental phosphorus and elemental sulfur. The preliminary cathode layer may contain only a sulfide having a phosphorus element and a sulfur element, and may further contain other elements (for example, Ge, Sn, Si, B, or Al) and a sulfide having a sulfur element. In the latter case, the preliminary cathode layer preferably contains a sulfide containing elemental phosphorus and elemental sulfur as a main component of the sulfide.

The sulfide preferably contains an ortho structure of phosphorus element. Examples of the ortho structure of the phosphorus element include, but are not limited to, a PS₄ structure. In addition, the sulfide may contain an orthostructure of an element M (M is, for example, Ge, Sn, Si, B, or Al). Examples of the ortho structure of the M element include, but are not limited to, GeS₄ structure, SnS₄ structure, SiS₄ structure, BS₃ structure, AlS₃ structure, and the like. On the other hand, the sulfide may contain a sulfide of a phosphorus element (for example, P₂S₅). The sulfide may have a sulfide of the M element (MₓS_{y}). Here, x and y are integers that give electrical neutrality with S depending on the type of M. Examples of the sulfide (MₓS_{y}) include, but are not limited to, GeS₂, SnS₂, SiS₂, B₂S₃, Al₂S₃, and the like.

The elemental sulfur in the sulfide and the elemental sulfur in the elemental sulfur or sulfur compound as the positive electrode active material may have a chemical bond (S—S bond). In particular, it is preferable that the sulfur element in the orthostructure and the sulfur element in the elemental sulfur as the positive electrode active material have a chemical bond (S—S bond).

In the preliminary cathode layer, the ratio of the mole of the phosphorus element to the sulfur element (phosphorus element/sulfur element) is not particularly limited, but may be 0.03 or more, 0.06 or more, 0.09 or more, or 0.12 or more, 0.50 or less, 0.30 or less, or 0.27 or less. The denominator of the molar ratio (phosphorus element/sulfur element) means the amount of all the sulfur elements included in the preliminary cathode layer. In the present disclosure, since both the positive electrode active material and the sulfide contain a sulfur element, the total amount of both sulfur elements is used.

### Elemental Lithium in the Preliminary Electrode Layer

The preliminary cathode layer may be substantially free of lithium elements. “Substantially free of lithium elements” means that the ratio of lithium elements to all elements included in the preliminary cathode layers is less than or equal to 20 mol %. The percentage of the lithium-element may be 15 mol % or less, 10 mol % or less, 5 mol % or less, or 1 mol % or less.

A positive electrode mixture containing a solid electrolyte having a lithium element is known. For example, when a solid-state electrolyte using Li₂S is used as a raw material, a battery using such a positive electrode mixture material as a cathode layer tends to have a low capacity due to the low water resistance of Li₂S. On the other hand, when the lithium element (for example, Li₂S) is substantially not contained in the preliminary cathode layer in the manufacturing method of the lithium sulfur battery of the present disclosure, the capacity decrease of the lithium sulfur battery can be suppressed.

For the first solid electrolyte layer, the second solid electrolyte layer, and the anode layer, reference can be made to the description of “Configuration of Lithium Sulfur Battery” above.

The method of forming the laminate of the preliminary laminate is not particularly limited, but specifically, for example, the first solid electrolyte layer is superimposed on the preliminary cathode layer and pressed to obtain a laminate of the preliminary cathode layer and the first solid electrolyte layer. Next, the second solid electrolyte layer and the anode layer are laminated in this order on the first solid electrolyte layer of the laminate, and the positive and negative electrode terminals are connected and sealed with a laminate film.

### Formation of the Cathode Layer

In the method for producing a lithium sulfur battery of the present disclosure, a part of sulfur of the preliminary cathode layer and a sulfide containing a phosphorus element and a sulfur element may be reacted with lithium to produce a sulfide solid electrolyte by performing a discharge operation on the preliminary laminate. Thus, the cathode layer may be formed.

### Discharge Operation

The discharge operation is not particularly limited, but can be performed in a temperature environment of 60° C. or higher. The temperature environment may be 80° C. or higher, or 100° C. or higher, or 200° C. or lower. Normally, a discharge operation is performed on the preliminary laminate in a state in which the surface temperature of the preliminary laminate is the same as the ambient temperature.

The discharge rate in the discharge operation is not particularly limited, but is, for example, 0.01C or higher, 0.05C or higher, or 0.10C or higher, and may be 0.50C or less, or 0.33C or less.

When discharging is performed, the preliminary electrode stack may be restrained, and the preliminary electrode layers may be restrained by, for example, 1 MPa, but is not limited thereto.

Preferably, the sulfide serves as an ion conduction path during charging and discharging. During discharge, lithium ions are conducted from the anode layer to the preliminary cathode layer via the second solid electrolyte and the first solid electrolyte, but lithium ions that have reached the preliminary cathode layer react with the positive electrode active material. When the sulfide is not present in the preliminary cathode layer, the discharge product of sulfur (for example, Li₂S) as the positive electrode active material has a low ionic conductivity, so that the ion conduction path in the preliminary cathode layer is insufficient, and thus the discharge process is less likely to proceed. On the other hand, when the sulfide is present in the preliminary cathode layer, even if the ion conductivity of the discharge product of sulfur (for example, Li₂S) as the positive electrode active material is low, the ion conduction path in the preliminary cathode layer is ensured by the sulfide, and thus the discharge reaction tends to proceed.

The present disclosure will be described in more detail with reference to the following examples, but the scope of the present disclosure is not limited to these examples.

### Example 1

### Preparative Cathode Layer Fabrication

Sulfur(S) as a positive active material (42 mass parts), phosphorus pentasulfide as a sulfide containing elemental phosphorus and elemental sulfur (P₂S₅) (23 mass parts), and gas phase growth method carbon fiber (Vapor Grown Carbon Fiber; VGCF) as a conduction aid (35 mass part) were mixed by ball milling. The obtained mixed powder is charged into a polypropylene (PP) container, 5 wt % of a styrene-based binder as a binder and a mesitylene is added, and dispersed for 30 seconds in an ultrasonic dispersing device (manufactured by UH-50 Co., Ltd.). Next, the dispersed mixture was shaken with a shaker (TTM-1 manufactured by Shibata Scientific Co., Ltd.) for 30 minutes to prepare a preliminary positive electrode mixture slurry. The obtained preliminary positive electrode mixture slurry is prepared and applied on an aluminium (Al) foil as a positive electrode current collector using an applicator by a blade method such that a basis weight is 7.6 mg/cm². Thereafter, the preliminary positive electrode mixture slurry was naturally dried, and dried on a hot plate heated to 100° C. for 30 minutes to obtain a preliminary cathode layer formed on Al foil.

### Preparation of Sulfide Solid Electrolyte Layer

L₂S—P₂S₅ based glass ceramics containing lithium iodide (LiI) were mixed by a ball mill and fired to obtain a sulfide solid electrolyte. Next, the obtained sulfide solid electrolyte is charged into a PP container, a 5 wt % heptane solution of a butylene rubber-based binder as a binder, and heptane are added, and the mixture is dispersed for 30 seconds by an ultrasonic dispersing device (UH-50 manufactured by SMT Co., Ltd.). Then, the mixture subjected to the dispersing treatment was shaken with a shaker (TTM-1 manufactured by Shibata Scientific Co., Ltd.) for 30 minutes to prepare a sulfide solid electrolyte mixture slurry. The sulfide solid electrolyte mixture slurry was applied to PET film by a blade method using an applicator, and dried by a natural drying method on a hot plate heated to 100° C. for 30 minutes to obtain a coating film formed on PET film. The coating surfaces of the coating films formed on PET films were superposed and pressed at 7 tonnes, and then PET films were peeled off to obtain sulfide solid electrolyte layers.

### Preparation of Polymer Electrolyte Layer

Polyethylene oxide (PEO) and bis(trifluoromethanesulfonyl)imide lithium (LiTFSI) were dissolved in acetonitrile. Here, the molar ratio (EO/Li) of C₂H₅O units (EO units) of the polyethylene oxide to the lithium (Li) element contained in LiTFSI was prepared so as to be EO/Li=20/1 (molar ratio). To this solution was added 10% by weight of benzoyl peroxide (BPO) as an initiator, based on the combined amounts of PEO and LiTFSI, and stirred until a homogeneous solution was obtained to prepare a polymer electrolyte-layer precursor solution. The polymer electrolyte precursor solutions are then applied to polyethylene terephthalate (PET) films by a blade method using an applicator and dried on a hot plate heated to 100° C. for 30 minutes. PET films were then peeled off to obtain polymeric electrolyte layers.

### Pre-Laminate A1 Fabrication

Metallic lithium as the anode layer was punched into φ13.00 mm. Similarly, the polymer electrolyte layer and the sulfide solid electrolyte layer was punched into φ14.50 mm, and the preliminary cathode layer was punched into φ11.28 mm. The sulfide solid electrolyte layer as the first solid electrolyte layer was superposed on the circular preliminary cathode layer, and then pressed at 7 tons to obtain a laminate of the preliminary cathode layer and the sulfide solid electrolyte layer. The polymer electrolyte layer as the second solid electrolyte layer and the metal lithium as the anode layer were laminated on the sulfide solid electrolyte layer of the laminate in this order, and the positive and negative electrode terminals were connected to each other and sealed with a laminate film to obtain a preliminary laminate A1.

### Fabrication and Electrochemical Assessment of Lithium Sulfur Battery B1

The preliminary laminate A1 was constrained by 1 MPa stresses with a metallic plate. It is then allowed to stand in a thermostat at 60° C., and discharge was measured by a constant current (0.06 mA/cm²) test in a range of the cut-off voltage of 1.2 to 3.1V to obtain a lithium sulfur battery B1. Then, the charge measurement was performed under the same constant current condition. The discharging capacity of the lithium sulfur battery B1 is 6.3 mAh, has a charge capacity of 5.0 mAh, and no short circuit occurred.

### Comparative Example 1

### Preparation of Preliminary Laminate a1, Preparation of Lithium Sulfur Battery b1, and Electrochemical Assessment

Metallic lithium as the anode layer was punched into φ13.00 mm. Similarly, the sulfide solid electrolyte layer was punched into φ14.50 mm, and the preliminary cathode layer. was punched into φ11.28 mm. A preliminary cathode layer processed into a circular shape was pressed at 7 tons, a sulfide solid electrolyte layer as a first solid electrolyte layer, and metallic lithium as an anode layer were laminated in this order on the preliminary positive and anode layers, and the positive and negative electrode terminals were connected and sealed with a laminated film to obtain a preliminary laminate a1. The preliminary laminate a1 is a laminate that does not include the polymer electrolyte layer, which is the second solid electrolyte layer, with respect to the preliminary laminate A1. The electrochemical evaluation of the preliminary laminate a1 was performed in the same manner as the electrochemical evaluation of the preliminary laminate A1 to obtain a lithium sulfur battery b1. The discharging capacity of the lithium sulfur battery b1 is 6.3 mAh, but the charge capacitance could not be obtained because a short circuit occurred.

### Comparative Example 2

### Preparation of Preliminary Laminate a2, Preparation of Lithium Sulfur Battery b2, and Electrochemical Assessment

Metallic lithium as the anode layer was punched into φ13.00 mm. Similarly, the polymer electrolyte layer was punched into φ14.50 mm, and the preliminary cathode layer was punched into φ11.28 mm. A preliminary cathode layer processed into a circular shape was pressed at 7 tons, a polymer electrolyte layer as a second solid electrolyte layer, and metallic lithium as an anode layer were laminated in this order on the preliminary positive and anode layers, and the positive and negative electrode terminals were connected to each other and sealed with a laminated film to obtain a preliminary laminate a2. The preliminary laminate a2 is a laminate that does not include the sulfide solid electrolyte layer, which is the first solid electrolyte layer, with respect to the preliminary laminate A1. The electrochemical evaluation of the preliminary laminate a2 was performed in the same manner as the electrochemical evaluation of the preliminary laminate A1 to obtain a lithium sulfur battery b2. The discharge capacity of the lithium sulfur battery b2 is 1.3 mAh, the charge capacity is 0.8 mAh, and no short circuit occurred.

Table 1 shows the electrochemical evaluations of Example 1 and Comparative Examples 1 and 2.

TABLE 1

| | | | Comparative | Comparative |
|---|---|---|---|---|
| | | Example 1 | Example 1 | Example 2 |
| Lithium sulfur battery | | Lithium sulfur | Lithium sulfur | Lithium sulfur |
| | | battery B1 | battery b1 | battery b2 |
| First solid electrolyte | | Sulfide solid | Sulfide solid | None |
| layer | | electrolyte | electrolyte | |
| | | layer | layer | |
| Second solid | | Polymer | None | Polymer |
| electrolyte layer | | electrolyte | | electrolyte |
| | | layer | | layer |
| Evalua- | Presence or | None | Found | None |
| tion | absence of a | | | |
| results | short circuit | | | |
| | Discharge | 6.3 | 6.3 | 1.3 |
| | Capacity | | | |
| | [mAh] | | | |
| | Charge | 5.0 | (with short | 0.8 |
| | Capacity | | circuit) | |
| | [mAh] | | | |

In the lithium sulfur battery b1, the initial discharge measurement performed well, but a short circuit occurred in the charge measurement after the discharge measurement. It is presumed that the short circuit of the lithium sulfur battery b1 is caused by the fact that the sulfide solid electrolyte layer cannot follow the expansion of the cathode layer containing sulfur in the discharge-measurement, and cracks occur in the layer, whereby lithium is precipitated in the subsequent charge process.

The lithium sulfur battery b2 did not have a short circuit, but the initial discharging capacity was significantly reduced. It is presumed that this is because there is a barrier in the lithium insertion from the polymer electrolyte layer to the cathode layer containing sulfur, and thereby the positive electrode active material and the lithium did not proceed sufficiently.

On the other hand, the lithium sulfur battery B1 works well in the first discharge-measurement, and discharge capacitance of 6.3 mAh is obtained, and also in the charge measurement after the discharge measurement, charge capacitance of 5.0 mAh could be obtained and no short circuit occurred. As described above, it has been clarified that by disposing the sulfide solid electrolyte between the cathode layer containing sulfur and the polymer electrolyte layer, a short circuit caused by charge and discharge can be suppressed and a high battery capacity can be obtained.

While preferred embodiments of the lithium sulfur battery and method of making the lithium sulfur battery of the present disclosure have been described, those skilled in the art will appreciate that changes can be made without departing from the scope of the claims.

What is claimed is:

1. A lithium sulfur battery comprising a cathode layer, a first solid electrolyte layer, a second solid electrolyte layer, and an anode layer in a stated order, wherein
the first solid electrolyte layer includes a sulfide solid electrolyte, and
the second solid electrolyte layer includes a polymer electrolyte and/or a gel electrolyte.

2. The lithium sulfur battery according to claim 1, wherein:
the anode layer includes an anode current collector layer; and
lithium ions that have migrated from the cathode layer during charging are deposited as metallic lithium between the second solid electrolyte layer and the anode current collector layer.

3. The lithium sulfur battery according to claim 1, wherein the second solid electrolyte layer includes the polymer electrolyte.

4. The lithium sulfur battery according to claim 3, wherein the polymer electrolyte includes polyethylene oxide.

5. A method for manufacturing the lithium sulfur battery according to claim 1, the method comprising the steps of:
forming a preliminary laminate by laminating a preliminary cathode layer containing sulfur and a sulfide containing a phosphorus element and a sulfur element, the first solid electrolyte layer, the second solid electrolyte layer, and the anode layer in a stated order; and
forming the cathode layer by generating a sulfide solid electrolyte by causing part of the sulfur and the sulfide containing the phosphorus element and the sulfur element in the preliminary cathode layer to react with lithium through a discharge operation on the preliminary laminate.
